(19) United States
(12) Patent Application Publication
(10) Pub. No.: US 2014/0122855 A1
(43) Pub. Date: May 1, 2014

(54) Method for Offline Configuration of a Field Device

(71) Applicant: Michael Maneval, Schopfheim (DE)

(72) Inventor: Michael Maneval, Schopfheim (DE)

(73) Assignee: Endress + Hauser Process Solutions AG, Reinach (CH)

(21) Appl. No.: 14/110,553

(22) PCT Filed: Mar. 23, 2012
(86) PCT No.: PCT/EP2012/055177

§ 371 Date: Dec. 17, 2013

(30) Foreign Application Priority Data
Apr. 14, 2011 (DE) 10 2011 007 384.1

(51) Int. Cl. G06F 9/44

(52) U.S. Cl. CPC G06F 9/4401
USPC 713/1

(57) ABSTRACT

A method for offline configuration of a predetermined field device type having an integrated web server. The field device is intended to be applied at a process point in an automated process plant. Field devices of different field device types having integrated web servers are physically provided by a service provider, wherein a customer connects via Internet to the respective field device type corresponding to the field device to be configured. The field device of the predetermined field device type is so configured via the Internet that it meets requirements for use at the process point in the process plant, wherein, after terminating the offline configuration, the device configuration data are so held that the customer has access to the device configuration data, and wherein upon later mounting of the field device at the process point in the process plant the offline produced, device configuration data can be made available to the field device.

The invention relates to a method for offline configuration of a field device of a predetermined field device type having an integrated web server, wherein the field device is intended to be applied at a process point in an automated process plant, however, at the point in time of the configuration is not yet mounted in the process plant or not yet connected for communication in the process plant. Another terminology used for the configuration of a field device in the sense of the present invention is the parametering of a field device.

In process automation as well as in manufacturing automation, field devices are often applied, which serve for registering and/or influencing process variables. Serving for registering process variables are measuring devices, such as, for example, fill level measuring devices, flow measuring devices, pressure- and temperature measuring devices, pH-measuring devices, conductivity measuring devices, etc., which register corresponding process variables, fill level, flow, pressure, temperature, pH-value, and conductivity, respectively. Used for influencing process variables are actuators, such as valves or pumps, via which e.g. the flow of a liquid in a pipeline or the fill level of a medium in a container is changed. The terminology ‘field devices’ in connection with the invention is, thus, intended to include all types of measuring devices and actuators.

Moreover, the terminology ‘field devices’ in connection with the invention also includes all devices applied near to the process and delivering or processing information relevant to the process. Besides the above mentioned measuring devices/sensors and actuators, also referred to as field devices are generally any units, which are connected directly to a fieldbus and serve for communication with the superordinated unit, thus units such as e.g. remote I/Os, gateways, linking devices and wireless adapters, respectively radio adapters. A large number of such field devices are produced and sold by the Endress Hauser group of firms.

In modern industrial plants, communication between at least one superordinated control unit and the field devices occurs, as a rule, via a bus system, such as, for example, Profibus® PA, Foundation Fieldbus® or HART®. The bus systems can be embodied both with wire as well as also wirelessly. The superordinated control unit serves for process control, process visualizing, and process monitoring as well as for commissioning and servicing of the field devices and is also referred to as a configuration/management system.

The integration of field devices into configuration- or management systems occurs via device descriptions, which assure that the superordinated control units can detect and interpret the data delivered from the field devices. As a rule, the respective device manufacturers provide the device descriptions for each field device type, respectively for each field device type as a function of application. In order that the field devices can be integrated into different fieldbus systems, different device descriptions must be created for the different fieldbus systems. Thus there are—to name only some examples—HART-, Fieldbus Foundation- and Profibus device descriptions. The number of device descriptions is very large and corresponds to the large number of different field devices, respectively field device types, as used in different applications and with different bus systems.

For the purpose of creating a universal description language for field devices, the Fieldbus Foundation (FF), the HART Communication Foundation (HCF) and the Profibus Nutzerorganisation (User Organization—PNO) have created a universal electronic device description language (Electronic Device Description Language EDDL). The EDDL, respectively the corresponding Electronic Device Description EDD, is defined in the standard IEC 61804-2.

Always becoming ever more important in automation technology is industrial Ethernet. Examples of industrial Ethernet include: HSE, ControlNet, Industrial IP, Profi-Net, and HART UDP/TCP. Field devices connected with a superordinated control unit via industrial Ethernet usually also have a web server. The web server enables servicing, thus especially configuration, parametering or diagnosis, of a field device by means of a Web browser. In this connection, one speaks of a ‘single source’ approach. This approach has the advantage that no device driver needs to be provided. In this way, configuration, respectively management, problems can be largely excluded.

In principle, servicing of field devices is only possible online via a service unit connected or connectable with the field device.

Known from non-prepublished DE 10 2009 054 901.3 filed by Codewrights GmbH on Dec. 17, 2009, is a method for offline parametering of a field device of process automation by means of a service unit. Also in this case, a web server is associated with the field device. The service unit includes a web browser. The method described in DE 10 2009 054 491.3 includes method steps as follows:

The service unit connects via its web browser with the web server of the field device to be serviced. A control logic provided by the web server is loaded into the web browser. The control logic starts the download of offline web pages, which are present in the web server or produced by it, and loads the web pages and the respective configuration data of the field device into the service unit. The current configuration data are processed or created in the service unit offline taking into consideration the web pages and the respectively loaded configuration data.

An object of the invention is to provide a method, which significantly reduces the time required for commissioning of a process plant.

The object is achieved by the method of the invention, which has steps as follows:
different field device types equipped with integrated web server are physically provided by a service provider;
a customer connects via Internet to the respective field device type corresponding to the field device to be configured;
the field device of predetermined field device type is so configured via Internet that it meets requirements for use at the process point in the process plant;
after terminating the offline configuration, the device configuration data are so held that the customer has access to the device configuration data; upon mounting the field device at the process point of the process plant at a later point in time, the offline produced, device configuration data of the field device are made available. Especially, the configuration data are loaded into the field device.

The method of the invention provides that the web server device configuration is prepared in the planning phase for the process plant, without the field device having to be available on-site, and the preconfigured data can at a later point in time, during the so-called commissioning phase for the process plant, be over-written in a short period of time into the field device. The time for the commissioning of the process plant can, in this way, be significantly reduced.

The invention describes, thus, a method for how, separated in time and location from the process plant, using a field device having an integrated web server, device configuration data can be created offline for preconfiguration of a field device, without that device drivers, respectively device type managers, must be created. The preconfigured device configuration data are then transferred during the commissioning phase within a short period of time into the field device mounted in the process plant.

An advantageous embodiment of the method of the invention provides that the accessing of the field device type, which corresponds to the field device to be configured, is made possible by the service provider for a predetermined time span in response to a corresponding request by the customer.

Furthermore, it is provided in connection with the method of the invention that the field device type, which corresponds to the field device to be configured, presents at the beginning of the offline configuration respective default configuration data, as preset by the manufacturer of the field device type at delivery of the field device. The default configuration data usually correspond to the factory settings of the field device.

An advantageous embodiment of the method of the invention provides that the accessing of the field device type is licensed by the service provider. Thus, access to a field device type can be granted upon receipt of a fee, or the access is governed by a contract. In the latter case, access to the field device type occurs preferably via a password.

In this connection, it is provided, furthermore, that, during the offline configuration by the customer, accessing of the field device type to be configured is blocked for offline configuration by another customer. In this way, it is assured that the offline configuration corresponds exclusively to the requirements of the first logged-on customer.

Moreover, it is provided that the customer, upon establishing the connection to the server of the service provider, is presented with a list of available field device types with web servers. The customer selects from the list the field device type, which corresponds to its field device to be configured. The field devices are, moreover, uniquely identified via an IP address in the network of the service provider and, in given cases, via the serial number of the field device.

An advantageous further development of the method of the invention provides that the device configuration data are stored locally at the customer. After mounting the field device in the process plant and during the commissioning of the field device, the device configuration data are loaded via a data bus into the associated field device. Moreover, there is the opportunity for the customer to load the locally stored device configuration data back into the server of the service provider, in order there, in given cases, to make modifications to the device configuration data.

Alternatively, it is provided that the preconfigured device configuration data are stored and managed by the service provider for the customer. Upon commissioning of the field device in the process plant, the field device accesses the device configuration data. Of course, the customer has the opportunity, in the case of a new application of the customer, to change the configuration in the server of the service provider.

Especially advantageous is when the device configuration data are stored as default device settings in the server of the service provider, so that the customer can subsequently access these default device settings for similar measuring points of the same field device type, respectively can prepare these for direct acceptance for the commissioning of the process plant.

The invention will now be explained in greater detail based on the drawing, the sole figure of which shows as follows:

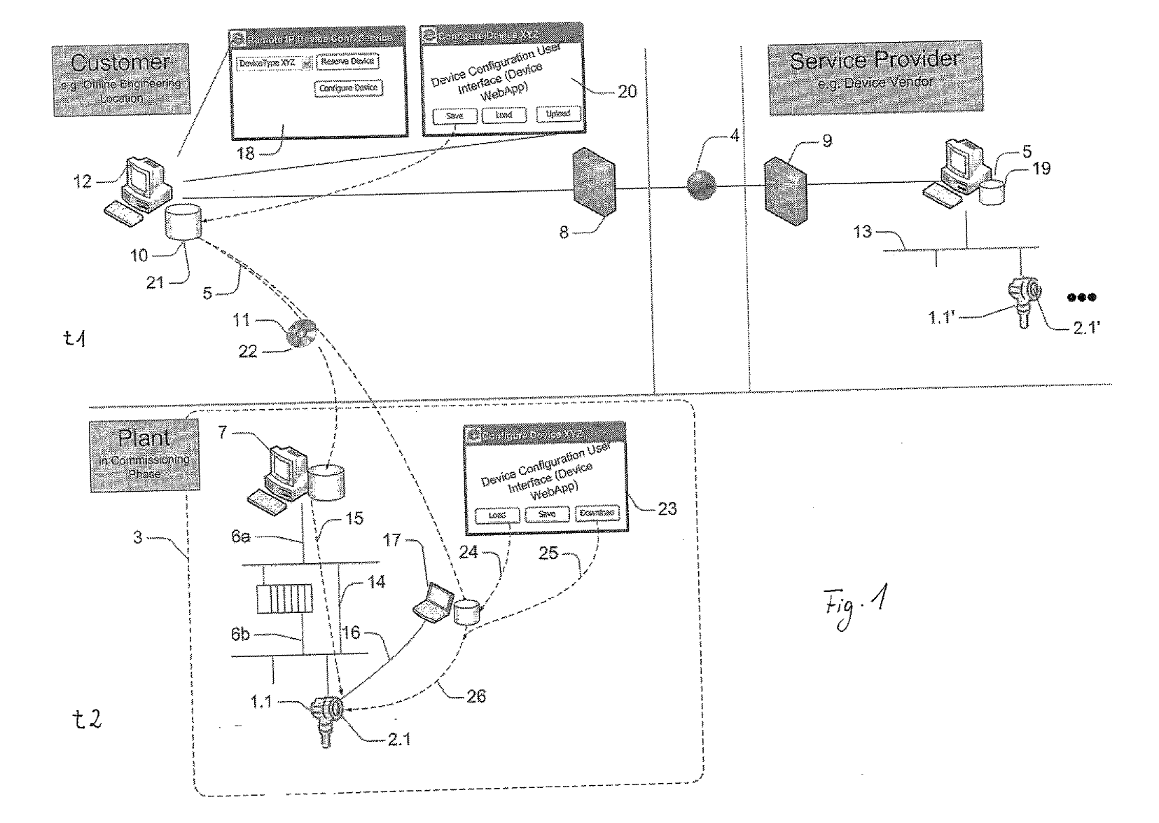

FIG. 1 an apparatus, respectively an arrangement or also a system, for performing the method of the invention, and, schematically, the method steps of a preferred embodiment of the method of the invention, wherein the sequence of the individual method steps is shown by the numbers 18-26.

The upper part of FIG. 1 shows, by way of example, an arrangement, with which, at a point in time t1, device configuration data are created offline for the field device 1.1′. At the point in time t1, when the device configuration data is being created, the field device 1.1 to be configured is not yet mounted in the process plant 3, respectively not yet connected for communication in the process plant 3.

For offline creation of the device configuration data, the customer establishes via a computer 12 connected to the Internet 4 contact with the server 5 of a service provider. The customer can be, for example, the operator of a process plant 3 or an engineering firm, which is designing, respectively engineering, the process plant 3. The service provider is, for example, a field device manufacturer and/or a field device vendor. In the illustrated case, both the customer and also the service provider are protected by firewalls 8, 9.

The server 5 of the service provider is connected with the fieldbus 13. Physically connected to fieldbus 13 is the field device 1.1′ of the same predetermined field device type and having an integrated web server 2.1′. Field device 1.1′ of the predetermined field device type is so-to-say a stand-in for the field device 1.1 of the same field device type. The dots beside the field device 1.1′ indicate that other field devices 1.2′, 1.3′, . . . of other field device types are likewise arranged in the fieldbus system 13, respectively can be arranged, and can be accessed by the customer via Internet 4. Possible field devices, which can be utilized in connection with the invention, have already been mentioned above in the introduction.

The field device 1.1 shown in the lower part of the arrangement likewise has an integrated web server 2.1.

The lower part of FIG. 1 shows a process plant 3 at a point in time t2. Point in time t2 is a point in time occurring after the point in time t1. Especially, the point in time t2 is the point in time when the field device 1.1 is to be placed in operation in the process plant.

Via a fieldbus 6a arranged at the field level and a data bus 6b arranged at the system level, field device 1.1 is connected with a superordinated control unit installed in a computer. In case the fieldbus 6a and the data bus 6b use different protocols, a conversion of the different protocols occurs in the control unit 14 near the field level. Installed on the fieldbus 6a at a predetermined process point in the automated process plant 3 is the field device 1.1 having an integrated web server 2.1 and being of a predetermined field device type. Field device 1.1′ and field device 1.1 are of the same field device type. Usually, a field device 1.1 having an integrated web server 2.1 is connected via Ethernet and can be communicated with via an Ethernet protocol. Via this connection, the preconfigured device configuration data are loaded into the field device 1.1.

An advantageous embodiment of the method of the invention includes the following method steps 18-26:

In the first step 18, the Customer connects with an Internet page of the Service Provider and expresses an interest in offline device configuration by means of web browser, e.g. by means of Microsoft Internet Explorer.

In the second step 19, the Service Provider transmits to the customer information concerning access for offline device configuration and concerning the length of time available for the offline device configuration. During the offline device configuration by the customer, accessing of the field device 1.1′ of the field device type for an offline device configuration by another customer is blocked. Preferably, the customer is provided at the beginning of the offline configuration with device configuration data as preset by the manufacturer of the field device 1.2 of the field device type for delivery of the field device 1.2. These are especially the ex-factory settings.

In the third step 20, the customer logs-in at the server 5 of the service provider 1 and starts the offline configuration of the field device 1.1′ of the selected field device type. The parametering, respectively the configuring, occurs as if the field device 1.1 is already installed at the provided measuring point in the process plant 3, although this is still not yet the case at the point in time T1 of the offline device configuration.

In the fourth step 21, the offline configured data are stored as a data set in a local file of the customer or in a database of the customer. With the fourth step 21, the preconfiguration of the field device 1.1′ is terminated. The customer then configures other field devices, or it signs-off from the server 5 of the service provider.

In the fifth step 22, the offline configured data are made available in the process plant 3.

In the sixth step 23, the Web application is started in the field device 1.1. For this, field device 1.1 is accessed via an Ethernet connection.

In the seventh step 24, after connection of the computer 7 with the web server 2.1 of the field device 1.1, the file with the offline produced, device configuration data is loaded into the field device 1.1. For example, the file, respectively the database, can be loaded (eighth and ninth steps 25 and 15, respectively 26) into the field device 1.1 via a Web client after mounting the field device 1.1 in the process plant 3 and after establishing the communication connection at the time of commissioning.

This can occur especially via two embodiments. On the one hand, the Web client can be started in a central computer 7, when an Ethernet connection 15 to the field device 1.1 is present.

On the other hand, the Web client can be started in a mobile device 17, when the field device 1.1 has a separate LAN connection for a second connection 16.

As already mentioned above, it is, furthermore, provided that the locally stored device configuration data can be loaded by the customer into the server 7 of the service provider, in order there to modify the device configuration data. If the customer has a number of field devices 1.1, 1.2, of the same device type, which need to be preconfigured, then it is sufficient to change the IP address. In such case, the presence of corresponding network configurations is assumed.

Also, it is provided that the device configuration data are stored as default device settings on the server 7 of the service provider, so that the customer can use these default device settings also for similar measuring points with field devices 1.2, 1.2, of the same field device type, respectively can prepare these for the commissioning in the process plant 3. For instance, the customer can select default settings of the field device configuration data, which specially fit its needs.

### LIST OF REFERENCE CHARACTERS

1.1, 1.2, . . . field device of a field device type

1.1′, 1.2′, . . . field device of a field device type

2.1, 2.2, . . . web server in the field device

2.1′, 2.2′, . . . web server in the field device

3 process plant

4 Internet

5 server of the service provider

6, 6a, 6b data bus

7 server of the customer

8 firewall of the service provider

9 firewall of the customer

10 data memory

11 mobile data memory

12 computer

13 data bus

14 control unit

15 Ethernet LAN connection

16 Ethernet LAN connection

17 mobile servicing device or computer

1-11. (canceled)

12. A method for offline configuration of a field device of a predetermined field device type having an integrated web server, the field device is intended to be applied at a process point in an automated process plant, however, at the point in time of creation of the device configuration data is not yet mounted in the process plant or not yet connected for communication in the process plant, wherein field devices of different field device types having integrated web servers are physically provided by a service provider, comprising the steps of:
a customer connects via the Internet to a respective field device type corresponding to the field device to be configured;
configuring the field device of predetermined field device type via the Internet that it meets requirements for use at the process point in the process plant;
after terminating the offline configuration, the device configuration data are so held that the customer has access to the device configuration data; and
upon later mounting of the field device at the process point in the process plant the offline produced, device configuration data of the field device are made available to, respectively are loaded into, the field device.

13. The method as claimed in claim 12, wherein:
the accessing of the field device of the field device type, which corresponds to the field device to be configured, is made possible by the service provider for a predetermined time span in response to a corresponding request by the customer.

14. The method as claimed in claim 12, wherein:
the field device of the field device type, which corresponds to the field device to be configured, presents at the beginning of the offline configuration respective configuration data as preset by the manufacturer of the field device of the field device type at delivery of the field device.

15. The method as claimed in claim 12, wherein:
the accessing of the field device of the field device type is licensed by the service provider.

16. The method as claimed in claim 12, wherein:
during the offline configuration by the customer, accessing of the field device of the field device type to be configured is blocked for offline configuration by another customer.

17. The method as claimed in claim 12, wherein:
the customer, upon establishing the connection to the server of the service provider, is presented with a list of available field devices of field device types with web servers; and
the customer selects from the provided list the field device type, which corresponds to its field device to be configured.

18. The method as claimed in claim 12, wherein:
the configuration data are stored in a local file of the customer.

19. The method after claim 12, wherein:
the preconfigured device configuration data are stored and managed by the service provider for the customer; and
in the case of commissioning the field device in the process plant at a later point in time, the customer can access the device configuration data.

20. The method as claimed in claim 12, wherein:
the configuration data are loaded via a data bus into the corresponding field device after mounting of the field device in the process plant and during commissioning of the field device.

21. The method as claimed in claim 12, wherein:
the locally stored device configuration data are loaded by the customer into the server of the service provider, in order there to make modifications to the device configuration data.

22. The method as claimed in claim 12, wherein:
the device configuration data are stored as default device settings in the server of the service provider, so that the customer can subsequently access these default device settings for similar measuring points with field devices of the same field device type, respectively can prepare these for commissioning in the process plant.
